(19) United States
(12) Patent Application Publication
(10) Pub. No.: US 2018/0358823 A1
(43) Pub. Date: Dec. 13, 2018

(54) Flexbattery

(71) Applicant: Technische Universiteit Eindhoven, Eindhoven (NL)

(72) Inventors: Erik Lemmen, Eindhoven (NL); Jorge Luiz Duarte, Eindhoven (NL); Marco Cornélis Marcel Drabbe, Eindhoven (NL); Jeroen Richard Gertruda Maar, Simpelveld (NL)

(73) Assignee: Technische Universiteit Eindhoven, Eindhoven (NL)

(21) Appl. No.: 15/781,243

(22) PCT Filed: Dec. 2, 2016
(86) PCT No.: PCT/EP2016/079578

§ 371 Date: Jun. 4, 2018

Related U.S. Application Data
(60) Provisional application No. 62/263,145, filed on Dec. 4, 2015.

(51) Int. Cl. H02J 7/00; H01M 10/42; H02M 3/158

(52) U.S. Cl. CPC H02J 7/0024; H01M 10/425; H02J 7/0054; H02J 3/32; H02J 7/0065; H02J 7/0068; H02M 3/1582; H02J 7/0055

(57) ABSTRACT

A power conversion and energy storage device is provided that includes port A, port B, port C, port D, an internal battery cell Bt1 having a negative pole connected to port C and a positive pole connected to port D, internal nodes N1 and internal node N2, an inductor L₁ having a negative terminal connected node N1 and a positive terminal connected to node N2, a switch S₁ configured to open or close an electrical connection between port A and the node N1, a switch S₃ configured to open or close an electrical connection between port C and node N1, a switch S₂ configured to open or close an electrical connection between port B and node N2, and a switch S₄ configured to open or close an electrical connection between port D and node N2, where a modular battery unit is formed.

### FIELD OF THE INVENTION

The present invention relates generally to energy storage. More particularly, the invention relates to a battery charging and discharging circuit that also generates a variable DC or AC voltage for electric loads.

### BACKGROUND OF THE INVENTION

Industrially assembled battery cells possess large variations from one batch to the next or within the same batch, where the variations include energy storage capacity, variability over time, and other specifications. When cells are placed in series and parallel the weakest cell determines how much energy can be drained from the pack. These industrial batteries lack the capacity to enable energy to be transported between cells, to strengthen the weakest cell, independent of any load. Therefore, not all the available energy from all cells can be used. The current state of the art requires cell matching, uniform cell chemistries, to optimize the usable energy storage.

As a rule in an electric drive system, batteries are coupled to a battery management system to provide the supervision of the battery cells, and further connected to an extra motor drive to control the motor. When the weakest cell reaches the empty point the system stops. Therefore the cells in a battery pack are cherry-picked to provide optimal performance. This approach does not take into account the aging effects and it is a quite expensive process.

What is needed is a battery system that releases the requirement of cell matching, and allows for mixing different cell chemistries to optimize a battery pack for a certain application, mixing high energy density, and mixing high power density cells and even (ultra-) capacitors enabling a high performance battery system.

### SUMMARY OF THE INVENTION

To address the needs in the art, a power conversion and energy storage device is provided that includes a port A, a port B, a port C, a port D, an internal battery cell Bt1 having a negative pole connected to the port C and a positive pole connected to the port D, internal nodes N1 and internal node N2, an inductor L1 having a negative terminal connected the internal node N1 and a positive terminal connected to the internal node N2, a switch S1 configured to open or close an electrical connection between the port A and the node N1, a switch S3 configured to open or close an electrical connection between the port C and the internal node N1, a switch S2 configured to open or close an electrical connection between the port B and the internal node N2, and a switch S4 configured to open or close an electrical connection between the port D and node N2, where a modular battery unit is formed.

According to one embodiment of the invention, any switch can include a transistor with an internal anti-parallel diode, or a transistor with an external anti-parallel diode. In one aspect, a first internal anti-parallel diode or a first external anti-parallel diode is connected in parallel to the switch S1, a second internal anti-parallel diode or a second external anti-parallel diode is connected in parallel to the switch S2, a third internal anti-parallel diode or a third external anti-parallel diode is connected in parallel to the switch S3 and a fourth internal anti-parallel diode or a forth external anti-parallel diode is connected in parallel to the switch S4.

In another embodiment of the invention, the internal battery Bt1 includes any number of battery cells connected in series or parallel.

In a further embodiment of the invention, the switch S1 and the switch S3 are closed and the switch S2 and the switch S4 are open, or the switch S1 and the switch S3 are open and the switch S2 and the switch S4 are closed, where the modular battery unit is configured for direct input-to-output operating mode states.

According to another embodiment of the invention, the modular battery unit further includes an input battery cell Bt0, where the input battery cell includes a positive terminal connected to port A and a negative terminal connected to the port B. In one aspect, the switch S1 and the switch S2 are closed, and the switch S3 and the switch S4 are open, or where the switch S1 and the switch S2 are open, and the switch S3 and the switch S4 are closed, where the modular battery unit is configured for buck-boost operation. In a further aspect, the modular battery unit is configured for the direct input-to-output operating mode states and configured for the buck-boost operation when only one of the switches S1, S2, S3, or S4 is open while the other switches are closed. In another aspect the embodiment further includes a trailing input half bridge and a trailing output half bridge, where the trailing input half bridge includes a Bx node disposed between a switch S0 and a switch S−1, where the switch S0 is connected between the Bx node and the port A, where the switch S−1 is connected between the Bx node and the port B, where the trailing output half bridge includes a By node disposed between a switch S5 and a switch S6, where the switch S5 is connected between the By node and the port D, where the switch S6 is disposed between the By node and the port C, where any the switch can include a transistor with an internal anti-parallel diode, or a transistor with an external anti-parallel diode, where a single unit battery pack Un is formed between the input port Bx and the output port By. In a further aspect any number of the singular base units are connected in cascade between the trailing input half bridge and the trailing output half bridge, where a flexbattery pack is formed. Here, any number of the flexbattery packs are connected in parallel, making a parallel connection of the internal battery cells of the parallel flexbattery units. Further, any number of the flexbattery packs are connected in series, making a series connection of the internal battery cells of the series flexbattery units. In a further aspect any number of the flexbattery packs are connected in parallel and further connected together with a series of inductors. In another aspect, any number of the flexbattery packs are connected in parallel and further connected together with a series of inductors disposed on each end of between the trailing input half bridge and the trailing output half bridge. According to another aspect, any number of the flexbattery packs comprising of any number of parallel and cascaded the flexbattery units are connected in parallel and further connected together with a series of inductors disposed on each end of between the trailing input half bridge and the trailing output half bridge. In another aspect, the current embodiment further includes an output inductor Lout and a voltage source Usrc, where the output inductor Lout includes an input port connected to the output port By and an output port connected to the voltage source Usrc, where the voltage source Usrc is connected between the output port By and the input port Bx and is configured to increase the energy storage level in the internal battery cells in the flexbattery pack. In another aspect the current embodiment further includes a current source Isrc, where the current source Isrc connected between the output port By and the input port Bx and is configured to increase the energy storage level in the internal battery cells in the flexbattery pack. Here, the current source is controlled such that the energy storage level in the internal battery cells in the flexbattery pack is increased.

According to one embodiment of the current invention, the modular battery unit is connected in cascade with at least one other the modular battery unit.

In another aspect of the current invention, the modular battery unit is connected in parallel with at least one other the modular battery unit.

In a further aspect of the current invention, the modular battery unit is arranged in a cascade of any number of the modular battery units.

According to one aspect the invention further includes a switch S_{F} disposed between the internal node N1 and the inductor L1, where a fault isolation single modular battery unit is formed. In one aspect the switch S_{F} can include a transistor, and a combination of series and parallel transistors, a fuse, and a electromechanical switch, where any of the other the switches is individually selected from the group consisting of a transistor with an internal anti-parallel diode, and a transistor with an external anti-parallel diode. In one aspect, a first internal anti-parallel diode or a first external anti-parallel diode is connected in parallel to the switch S1, a second internal anti-parallel diode or a second external anti-parallel diode is connected in parallel to the switch S2, a third internal anti-parallel diode or a third external anti-parallel diode is connected in parallel to the switch S3 and a fourth internal anti-parallel diode or a forth external anti-parallel diode is connected in parallel to the switch S4.

### BRIEF DESCRIPTION OF THE DRAWINGS

FIG. 1 shows a basic flexbattery unit, according to one embodiment of the invention.

FIG. 2 shows a basic flexbattery unit with anti-parallel diodes, according to one embodiment of the invention.

FIG. 3 shows the basic flexbattery unit of FIG. 1 where Bt1 is composed of an arbitrary combination (series/parallel) of battery cells, according to various embodiments of the invention.

FIGS. 4A-4B show a flexbattery unit direct input-to-output operating mode states, according to one embodiment of the invention.

FIGS. 5A-5B show the flexbattery unit configured for buck-boost operating mode states, according to one embodiment of the invention.

FIGS. 6A-6D show the flexbattery unit operating with both operating modes shown in FIGS. 4A-4B and FIGS. 5A-5B combined, according to one embodiment of the invention.

FIG. 7 shows a most elementary flexbattery pack, composed of a single flexbattery unit, input battery cell and trailing converters, according to one embodiment of the invention.

FIGS. 8A-8H show output levels of the single unit flexbattery pack shown in FIG. 7, according to one embodiment of the invention.

FIG. 9 shows the flexbattery pack composed of a cascade of repeating flexbattery units, according to one embodiment of the invention.

FIG. 10 shows a flexbattery pack of FIG. 9 composed of a cascaded of flexbattery units, and parallel connected flexbattery units, according to one embodiment of the invention.

FIG. 11 shows the flexbattery pack composed of parallel sub-packs, each composed of a cascade of flexbattery units. All connected together with series inductors, according to one embodiment of the invention.

FIG. 12 shows the flex battery pack of FIG. 11 having the inductors split into two inductors, according to one embodiment of the invention.

FIG. 13 shows a flexbattery pack composed of sub-packs, realized with a cascade and parallel connection of flexbattery units, according to one embodiment of the invention.

FIG. 14 shows a multiphase flexbattery composed of branches of cascaded flexbattery units, according to one embodiment of the invention.

FIG. 15 shows a multiphase flexbattery composed of flexbattery sub-packs per phase, according to one embodiment of the invention.

FIG. 16 shows a multiphase flexbattery composed of any number of phases of any number of flexbattery sub-packs, according to one embodiment of the invention.

FIG. 17 shows a flexbattery unit with fault isolating switch, according to one embodiment of the invention.

FIG. 18 shows a flexbattery unit with an inductance is placed in series with the battery pack (or the charging voltage source), according to one embodiment of the invention.

FIG. 19 shows a flexbattery unit with a current source applied for charging, according to one embodiment of the invention.

FIG. 20 shows a flexbattery unit with passive charging using anti-parallel diodes replacing some of the switches in FIG. 19 for conducting the charging current, according to one embodiment of the invention.

### DETAILED DESCRIPTION

The present invention is a new battery system that includes an electronic circuit for charging and discharging batteries, which combines the function of charge balancing with generation of variable DC or variable AC voltage supply for electric loads from the batteries. As a result, the battery pack does not have just a positive or negative terminal, but any number of terminals, all of which can operate at arbitrary voltage levels, positive or negative. Since each connection terminal can generate variable voltage from the batteries, within a predefined range, the system can also provide ac voltage supply. Therefore, with appropriate control this battery system can be directly applied to an electrical motor. Also, internal batteries of the system can be charged from any voltage level within the nominal output range, DC or AC. Moreover, since either charging or discharging is possible, the battery system can be coupled directly to the mains to act as an energy buffer for mains stabilization. Furthermore, apart from controlling a load, the energy stored by the batteries inside the system can be transported between battery cells to achieve charge equalization. This also allows for the use of multiple different types of chemistries in a single battery pack, and even allows mixed use of batteries and super capacitors to provide peak power. As described herein, this flexible combination of bidirectional charger and voltage inverter is referred to as a “flexbattery”.

With the increasing demand for the electrification of transportation, batteries play an increasingly important role. In most applications multiple battery cells are placed in series/parallel to form a battery pack with sufficient terminal voltage and stored energy. When forming a battery pack the capacity of all of the series-connected cells should be closely matched, since the weakest link determines the performance of the entire pack. The specifications of industrially manufactured battery cells may vary greatly, even between cells of the same batch and characteristics may change substantially over time. In the case of a battery pack with lithium cells, each individual cell must operate within strict voltage and temperature ranges during charging and discharging. Therefore, a battery management system (BMS) is required in order to provide monitoring of each individual cell and to enable active or passive charge balancing during charging/discharging.

Basic battery managements systems typically use switchable bypasses across each battery cell to balance them during charging. The pack is empty when the weakest cell reaches the empty point, therefore, the cells in a battery pack are cherry-picked. However, this approach does not take the ageing effects into account and it is a rather expensive and inefficient process. Newer approaches tend to focus on active balancing methods which use non-dissipative balancing, such as isolated dc-dc converters. A next step is more integration of the function of the battery and balancing. It can, however, only balance the cells using the load current. Integrating a switching power converter in each battery cell provides only moderate flexibility and poor efficiency. Other commercial approaches aggregate battery cells in a modular multilevel converter and integrate the function of BMS and motor drive, which rely on circulating currents for balancing.

With the current flexbattery invention, energy can be freely transported between battery cells of cascaded units, allowing for energy balancing independent of the load. As a result, no cherry-picked battery cells are required as the full energy content of each battery cell can be used. One may even combine different cell chemistries to optimize a battery pack for a certain application. With the direct input-to-output operation of the flexbattery units, an arbitrary output voltage can be presented at its terminals, both dc and ac. Therefore a flexbattery pack can be directly used for driving a load, such as an AC or DC motor, a loudspeaker or an LED torch. For applications requiring multiphase AC, a multiphase flexbattery pack can be assembled.

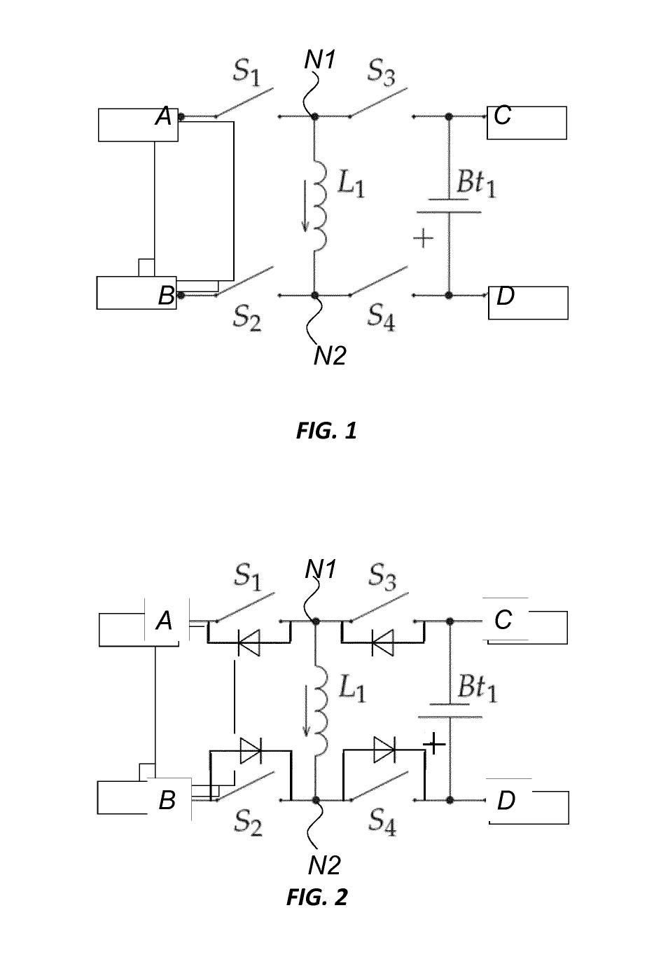

Turning now to the figures, FIG. 1 shows the basic building blocks of a flexbattery unit (FBU), also referred to as a modular battery unit. The FBU includes port A, port B, port C, port D, an internal battery cell Bt1 having a negative pole connected to port C and a positive pole connected to port D, internal nodes N1 and internal node N2, an inductor L₁ having a negative terminal connected node N1 and a positive terminal connected to node N2, a switch S₁ configured to open or close an electrical connection between port A and the node N1, a switch S₃ configured to open or close an electrical connection between port C and node N1, a switch S₂ configured to open or close an electrical connection between port B and node N2, and a switch S₄ configured to open or close an electrical connection between port D and node N2, where a modular battery unit is formed.

FIG. 2 shows a basic flexbattery unit with anti-parallel diodes, according to one embodiment of the invention. It is understood that any switch can include, a transistor, an internal anti-parallel diode, a fuse, or an external anti-parallel diode. As shown, a first diode is connected in parallel to the switch S1, a second diode is connected in parallel to the switch S2, a third diode is connected in parallel to the switch S3 and a fourth diode is connected in parallel to the switch S4.

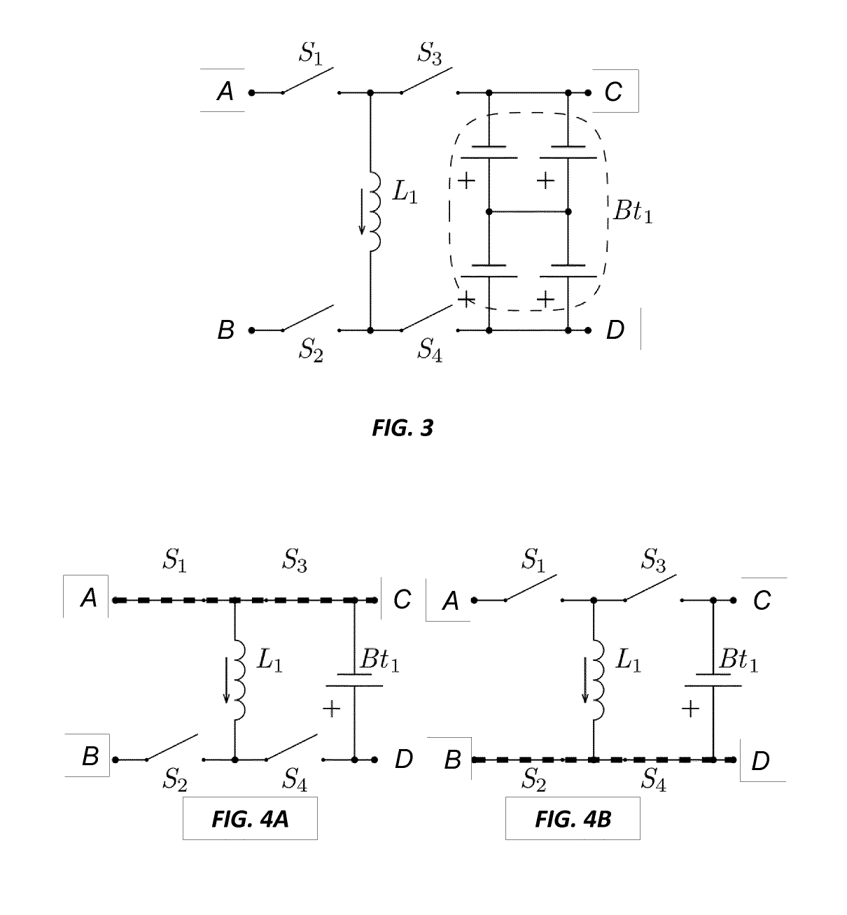

FIG. 3 shows the basic flexbattery unit of FIG. 1 where the internal battery cell Bt1 is composed of an arbitrary combination (series/parallel) of internal battery cells, according to various embodiments of the invention.

According to aspects of the current invention, operation of the basic FBU includes of two separate modes. One mode is the input-to-output direct connection, using switches S3 and S1 turned on simultaneously, or with switches S2 and S4 turned on simultaneously. Using the first pair of switches, as shown in FIG. 4A, terminal A is connected to A, with the second pair, terminal B is connected to D as given in FIG. 4B.

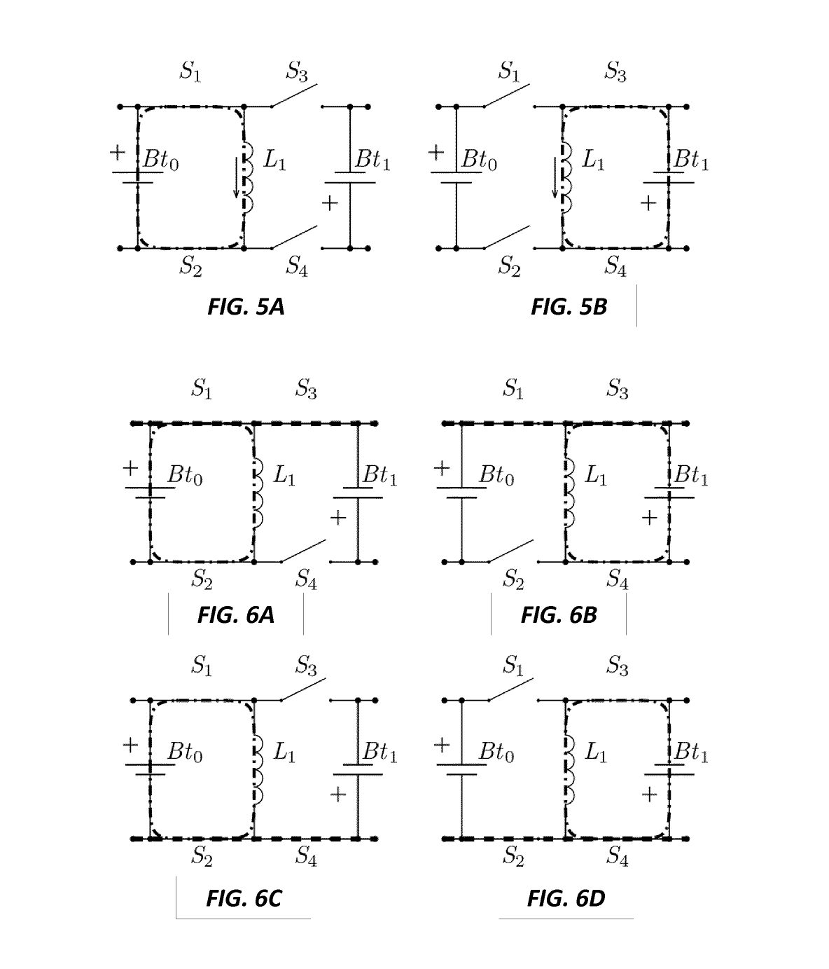

The second mode is the buck-boost operation. In the buck-boost operation, energy can be transferred between a battery cell connected between terminals A and B and Bt1. In the case of energy flow from the input battery cell (represented by Bt0) to the internal battery cell, the inductor is charged from the input in FIG. 5A and discharged to the internal battery cell in FIG. 5B. Operation of the FBU, with both input-to-output direct connection and buck-boost combined, is shown in FIGS. 6A-6D. Clearly, with ideal components, the input-to-output direct connection and the buck-boost operation do not influence each other. Within the FBU, the voltage rating of all switches is only determined by the sum of the input (Bt0) and internal battery cell (Bt1) voltage.

Typically the battery cells have low internal resistance, i.e. they behave like voltage sources. Therefore the buck-boost operation should not be used by setting a fixed duty ratio but by controlling the current through the inductor in the FBU.

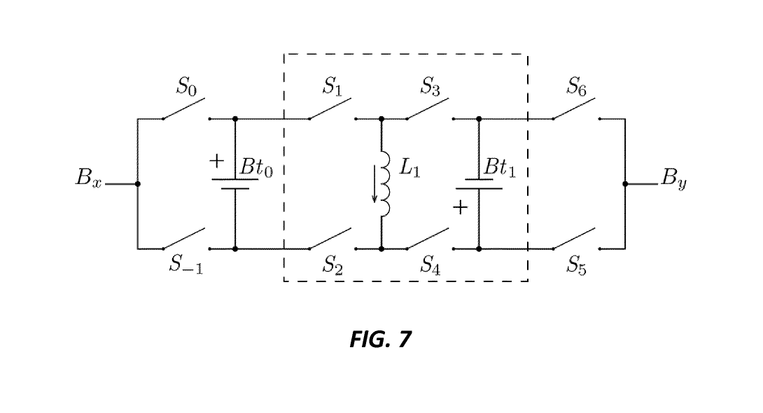

A FBU itself as shown in FIG. 1 is not convenient to be directly connected to a load, therefore a FBU should be extended with trailing converters to compose practical terminal voltage waveforms. For this purpose two trailing converters are required, one at either end of a cascade of FBUs. As such the most elementary flexbattery pack is drawn in FIG. 7, which is composed of a single flexbattery unit and two half-bridge converters together with an extra input battery cell.

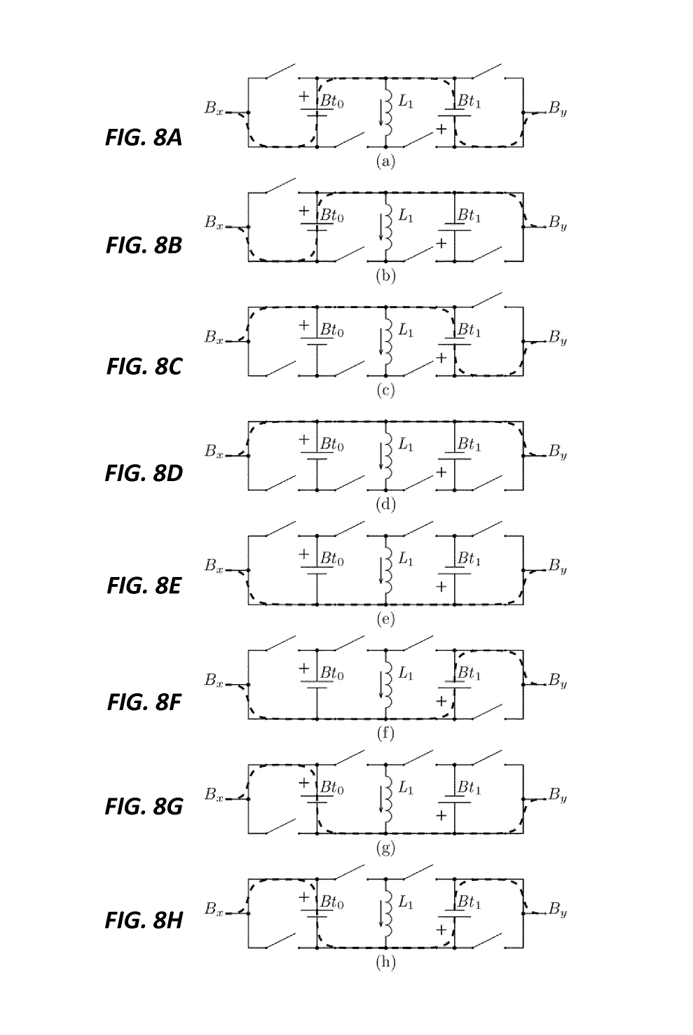

By adding the input trailing converter, formed by the half-bridge (HB) with switches S0 and S−1, and the battery cell Bt0, and the output half-bridge, formed by S5 and S6, the single unit flexbattery pack can provide a total of eight possible output levels (N=8). The levels are given in Table I, where uₒᵤₜ is defined as uB,y−uB,x. Each of the corresponding circuit configurations is drawn in FIGS. 8A-8H. With equal cell voltages some of the levels lead to the same output voltage, giving a total of five unique output levels (N′=5). Nevertheless, it is also possible to cascade multiple flexbattery units even with different internal battery cell voltages.

The configurations in FIGS. 8A-8H only show the direct input-to-output operation of the flexbattery unit. But as clear from the basic circuit operation, two switches within the FBU always remain available for buck-boost operation. Similar to the single-unit flexbattery shown in FIG. 7, a flexbattery pack may also be assembled using an arbitrary number of cascaded units.

TABLE I
SINGLE-UNIT FLEXBATTERY OUTPUT LEVELS

| l | uₒᵤₜ (u_{B, y} − u_{B, x} | FIG. |
|---|---|---|
| 4 | U_{Bt}_{₀} + U_{Bt}_{₁} | FIG. 8A |
| 3 | U_{Bt}_{₀} | FIG. 8B |
| 2 | U_{Bt}_{₁} | FIG. 8C |
| 1 | 0 | FIG. 8D |
| −1 | 0 | FIG. 8E |
| −2 | −U_{Bt}_{₁} | FIG. 8F |
| −3 | −U_{Bt}_{₀} | FIG. 8G |
| −4 | −U_{Bt}_{₀} − U_{Bt}_{₁} | FIG. 8H |

In a flexbattery pack, balancing can be achieved in two ways. The first one is by making use of redundant levels to spread the load over different battery cells. For example, when a single-unit flexbattery pack is used with equal cell voltages and an output voltage equal to a single cell voltage. Then levels l={2, 3} from Table I provide the same voltage. By switching between these circuit configurations the output voltage remains unchanged and the load can be spread over each of the battery cells.

When, however, the highest output level is required, there are no redundant cases. If in this situation there is unbalance in the cells, a second balancing method may be used. This is accomplished by using the buck-boost operation of the FBU. With the buck-boost operating mode, energy can be pumped from one unit to any of the neighboring units, independent of the momentary output level of the flexbattery pack and independent of the load. By means of this second balancing method, the full energy stored in each cell can be used.

The buck-boost operation balancing method is also independent of the internal cell voltage of any of the FBUs. When FBUs with different battery cell voltages are used, such that there are no redundant output levels, the buck-boost operation mode can still be applied for balancing.

Since the flexbattery pack can provide a variable DC, and even an AC voltage, it can be directly used for driving a load. One example application is a mobile audio amplifier, instead of having a battery pack and power amplifier, the flexbattery pack can generate the audio waveform. Therefore, the flexbattery pack can be directly, with some filtering, connected to the speaker. Another example application is a coupled energy storage system. Connecting a flexbattery pack to a main grid allows for bidirectional energy flow between the flexbattery pack and grid. In a household application for example, the flexbattery can be charged when renewable resources provide an abundance of energy (e.g. solar panels during the day), and during peak consumption hours, the flexbattery pack can supply the household, thereby off-loading the mains connection.

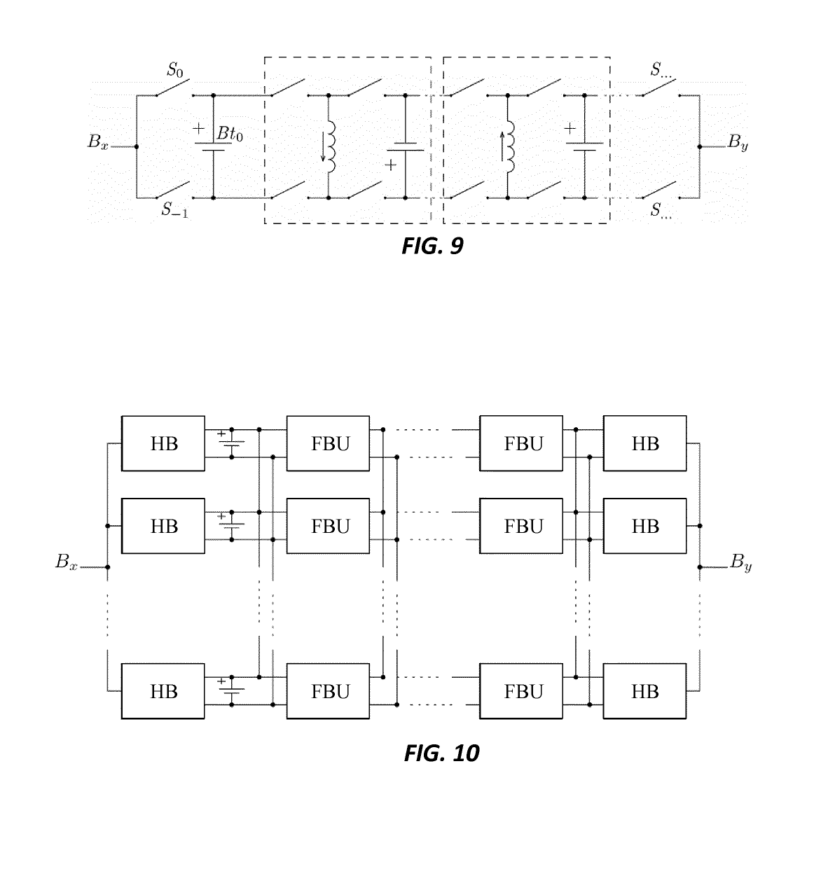

With the construction of a flexbattery pack with more than one flexbattery unit, as shown in FIG. 9, with equal cell voltages, the number of unique output levels N′ scales linearly with the number flexbattery units σ. For a basic single-unit flexbattery pack this relation is given by

N′=3+2σ

Using equal cell voltages has some advantages, like equal switch voltage rating in all flexbattery units, balancing through redundant levels and active balancing across all battery cells, as discussed further below. However, for the same number of levels the number of switches can be reduced when allowing for unequal battery voltages in the flexbattery pack. In the following an optimization is performed to find the maximum number of equidistant output levels for a given number of flexbattery units. The resulting solution given in per-unit values for the battery cell voltages is given in Table 2, together with the number of unique output levels and peak output voltage.

TABLE 2
Asymmetric flexbattery pack cell voltages with respect
to smallest unit (p.u.)

| σ | N′ | u_{Bt}_{₀} | u_{Bt}_{₁} | u_{Bt}_{₂} | u_{Bt}_{₃} | u_{Bt}_{₄} | u_{Bt}_{₅} | ûₒᵤₜ |
|---|---|---|---|---|---|---|---|---|
| 1 | 7 | 1 | 2 | — | — | — | — | 3 |
| 2 | 13 | 1 | 1 | 4 | — | — | — | 6 |
| 3 | 27 | 1 | 1 | 3 | 8 | — | — | 13 |
| 4 | 53 | 1 | 1 | 3 | 5 | 16 | — | 26 |
| 5 | 107 | 1 | 1 | 3 | 5 | 11 | 32 | 53 |

The desired voltage for battery cells Bt₀ to Bt_{σ-1} is given by

$${U}_{{Bt}_{η}} = \frac{{( - 1 )}^{η} + {2}^{η + 1}}{3}$$

where η is the identifier of the battery cells. The desired voltage for Bt_{σ} is then

U_{Bt}_{_{σ}}=2^{σ}

The number of unique output levels is found as

$${N}^{′} ( σ ) = {2}^{σ + 2} - \frac{{( - 1 )}^{σ} + {2}^{σ + 1}}{3}$$

Note that this is only one of many possible solutions. Because of symmetry of the flexbattery pack, reversing the order of the battery cells gives the same solution. However, other solutions still remain feasible, especially for flexbattery packs with more units as the number of possible solutions grows.

Besides the flexbattery pack, such as shown in FIG. 7, other variants can also be realized. In this section a few examples are given for extended pack constructions and multiphase applications or fault-tolerant operation on battery cell, and switch level.

For example, FIG. 10 shows a flexbattery pack of FIG. 9 composed of a cascaded of flexbattery units, and parallel connected flexbattery units, according to one embodiment of the invention. In this case the battery cells of each flexbattery unit are placed in parallel. The pack can be composed of any number of cascaded and parallel connected FBUs.

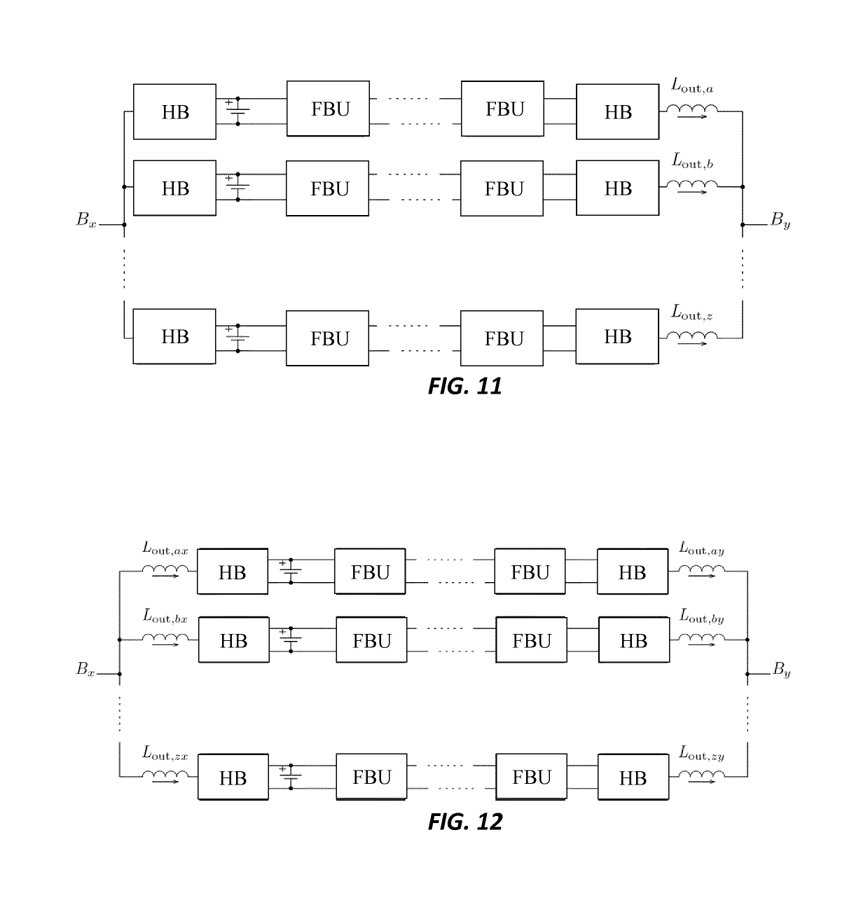

Another option for a flexbattery pack is given in FIG. 11 showing the flexbattery pack composed of parallel sub-packs, each composed of a cascade of flexbattery units. All connected together with series inductors, according to one embodiment of the invention. The balancing between sub-packs is done using a circulating current. This structure allows for easier construction of a fault tolerant version.

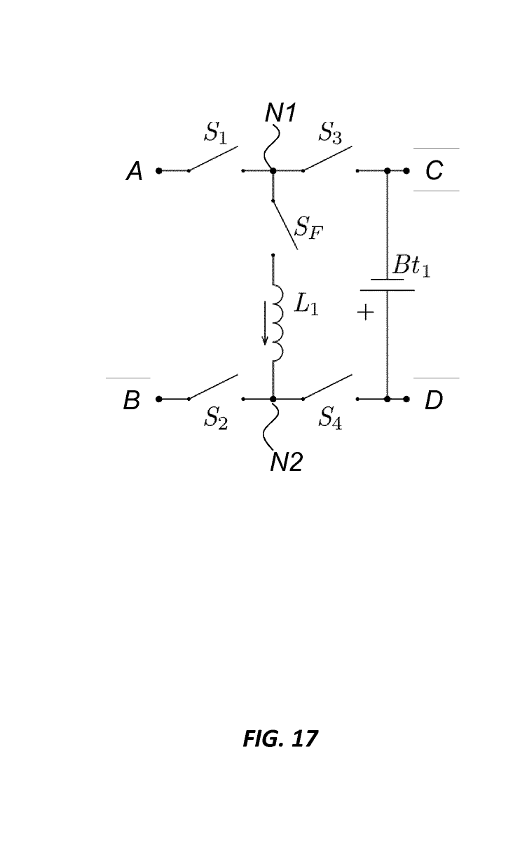

In a flexbattery pack, fault tolerance may be implemented as tolerance for failed battery cells or for switch failures, or even for both failure types. Depending on the desired type of fault tolerance, a system can be realized, where all battery cells of the parallel FBUs are placed in parallel. In case a single battery cell fails to a short circuit, the buck-boost operating mode of the adjacent units cannot be used for balancing any more, thereby limiting the performance of the pack. It does however provide good tolerance against switch faults, especially when applying the fault isolating unit of FIG. 17.

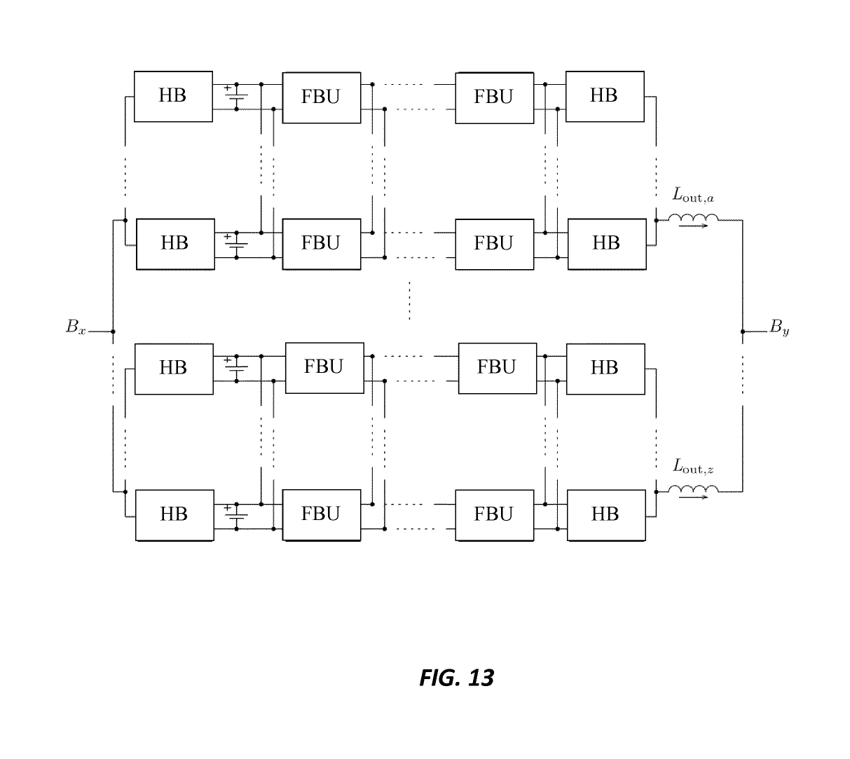

Using parallel flexbattery sub-packs the load current can be distributed among the different cells and switches. With appropriate control the sub-packs may be interleaved to reduce the output voltage and current ripple. In case of a shorted battery cell in one of the sub-packs, only the buck-boost balancing operation of that particular sub-pack is affected. Since each flexbattery pack acts as a voltage source, an inductor should be added in series with each sub-pack. An example flexbattery pack composed of sub-packs is given in FIG. 11 however the same structure can be used with any number of cascaded units and any number of parallel sub-packs. Alternatively to the circuit in FIG. 11 the inductor can also be split up, resulting in an inductor in series with each sub-pack terminal as shown in FIG. 12. FIG. 13 shows a flexbattery pack composed of sub-packs as presented in FIG. 10 according to the embodiment of the invention.

Within a flexbattery pack having multiple sub-packs, the internal battery cells of a sub-pack may be balanced using both the buck-boost operation mode and redundant output levels. Balancing cells of different sub-packs is done by controlling a circulating current from one sub-pack to another. This balancing is independent of the load current but not independent of the load voltage. In case of a battery cell failure in one of the sub-packs, the peak output voltage of the remaining sub-packs should be limited to the peak output voltage of the damaged sub-pack. This is to prevent a short circuit, as the damaged sub-pack clamps the voltage at its terminals to the remaining peak output voltage.

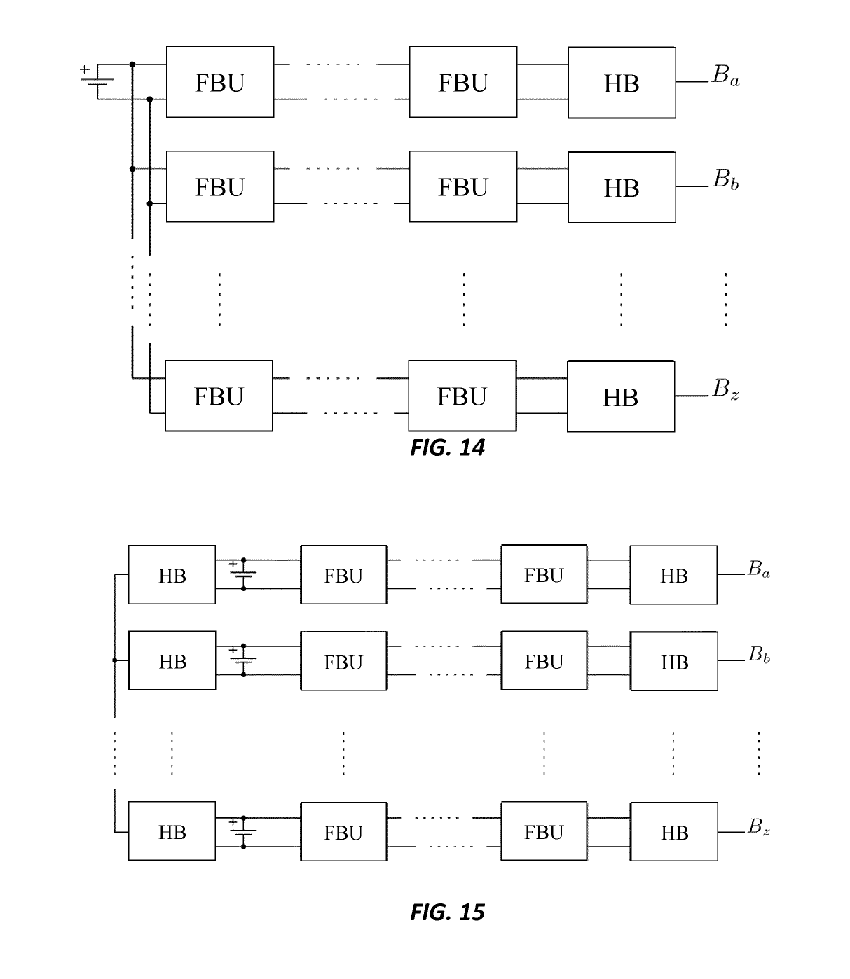

It is also possible to compose so-called multiphase flexbattery packs, having more than two output voltage terminals. Many variations of the multiphase flexbattery are possible, for example in FIG. 14 an input battery cell is shared by all phases therefore individual battery cells can also be balanced across all phases through this common cell. Each leg of the multiphase flexbattery pack can be constructed of any number of FBUs.

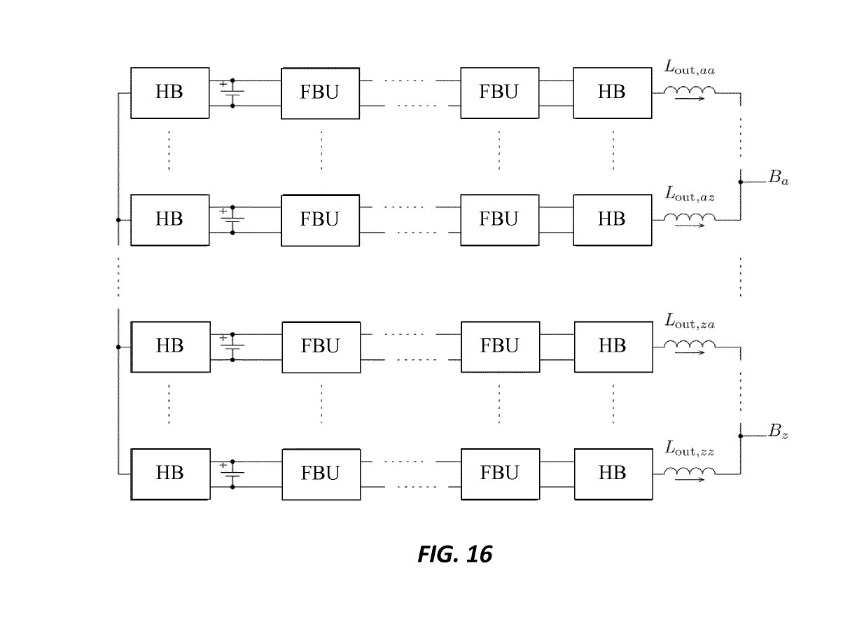

FIG. 15 shows a multiphase flexbattery composed of flexbattery sub-packs per phase, and FIG. 16 shows a multiphase flexbattery including any number of phases of any number of flexbattery sub-packs, according to different exemplary embodiments of the invention.

A multiphase flexbattery pack can be constructed with an arbitrary number of phases. Each of the phases can be used individually to provide a different output voltage. By making, for example, a six-phase flexbattery pack, two independent three-phase output voltages are realized. Allowing two independent AC to be controlled by the battery pack. Additionally, a seventh phase may be added for example to provide a variable auxiliary supply voltage.

For fault isolating, switch S_{Fη} should be capable of blocking voltage of both polarities when command “off”, and should conduct current of both polarities when commanded “on”. FIG. 17 shows a flexbattery unit with fault isolating switch, according to one embodiment of the invention.

Using the two decoupled means of energy transport, the battery cells can be balanced and a variable output voltage can be provided, with bidirectional flow of energy. Additionally multiphase and fault tolerant flexbattery packs can be composed where each output can provide any voltage level, both AC and DC. Charging of a flexbattery pack can be achieved by any kind of voltage source within the output range of the assembly, and can be fully controlled by the flexbattery pack, simplifying the charger requirements.

The flexbattery structure allows for two methods of charging, active charging, where the flexbattery controls the process, and passive charging, where it is controlled by an external charger. In case of the active method, the flexbattery pack can be charged from any non-zero voltage source or current source.

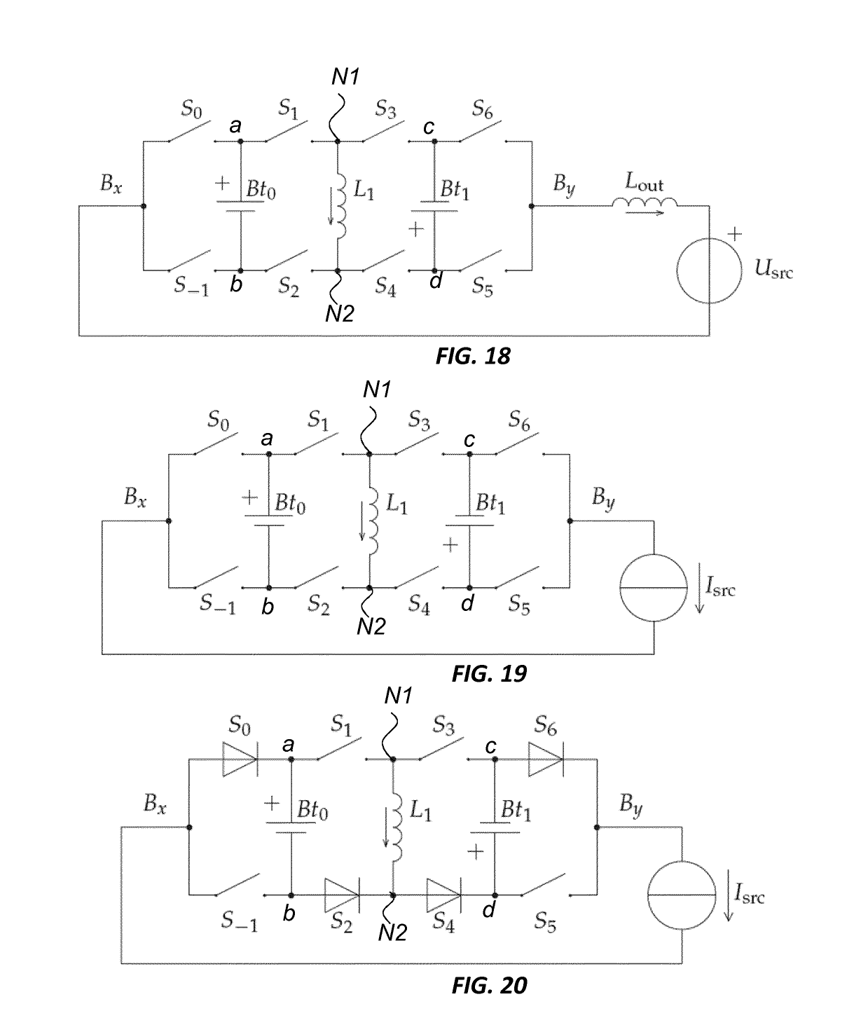

Active charging is a method of increasing the electrical charge in the internal battery cells of the flexbattery pack by actively controlling the switches of the pack. Due to the bidirectional nature of the FBU, the pack can be charged with any non-zero voltage that is within output range of the battery, where the charging is completely controlled by the flexbattery pack. It can be charged from either a DC voltage source (positive and negative) or an AC voltage source. The only requirement is that a small inductance is placed in series with the battery pack (or the charging voltage source) as shown in FIG. 18. The allowed charging voltage range is given by

$$- {\sum }_{η = 0}^{σ} {\hat{U}}_{{Bt}_{η}} \leq {U}_{src} \leq {\sum }_{η = 0}^{σ} {\hat{U}}_{{Bt}_{η}} ,$$

where Û_{Bt}_{_{η}} is the maximum allowed voltage across the internal battery cell of unit η. When charging with an ac voltage, it should always stay within this range.

Another option for charging is applying a current source as shown in FIG. 19. When using a current source there is no explicit need for a series inductor. In this case the charging is also completely controlled by the flexbattery pack. When all internal battery cells reach their maximum charge, the charging process can be stopped by shorting the current source using all top or all bottom switches. Distribution of the charging current internally over the battery cells may be done using the internal cell balancing, where both input-to-output operation with redundant levels and buck-boost operation can be used.

Besides the active charging mentioned above, the flexbattery pack can also be charged passively. In this case, the switches in the pack are not activated and one relies on the anti-parallel diodes of the switches for conducting the charging current. This situation is indicated in FIG. 20 where each diode indicates a conducting antiparallel diode of a switch. With passive charging the charging should be controlled by the source, i.e. by using an appropriate charging algorithm for the internal battery cells, such as constant-current constant-voltage charging. In that case the maximum charging voltage, U_{src}, should be limited to

$${\sum }_{η = 0}^{σ} {\hat{U}}_{{B}_{{t}_{η}}} + 2 ( 1 + σ ) {U}_{D , fwd}$$

where U_{D,fwd} is the forward voltage of the switch anti-parallel diode.

FIG. 20 shows passive charging with a positive current into the B, node of the flexbattery. The diodes indicate which of the switch anti-parallel diodes conduct. A current source with opposite or alternating polarity can be used. In case of an opposite polarity, the anti-parallel diodes of the other switches conduct the charging current.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1) A power conversion and energy storage device, comprising:
a) a port A, a port B, a port C, a port D;
b) an internal battery cell Bt1 having a negative pole connected to said port C and a positive pole connected to said port D;
c) an internal node N1 and an internal node N2;
d) an inductor L1 having a negative terminal connected said internal node N1 and a positive terminal connected to said internal node N2;
e) a switch S1 configured to open or close an electrical connection between said port A and said internal node N1;
f) a switch S3 configured to open or close an electrical connection between said port C and said internal node N1;
g) a switch S2 configured to open or close an electrical connection between said port B and said internal node N2; and
h) a switch S4 configured to open or close an electrical connection between said port D and internal node N2;
wherein a modular battery unit is formed.

2) The power conversion and energy storage device of claim 1, wherein any said switch is individually selected from the group consisting of a transistor with an internal anti-parallel diode, and a transistor with an external anti-parallel diode.

3) The power conversion and energy storage device of claim 2, wherein a first said internal anti-parallel diode or a first said external anti-parallel diode is connected in parallel to said switch S1, a second said internal anti-parallel diode or a second said external anti-parallel diode is connected in parallel to said switch S2, a third said internal anti-parallel diode or a third said external anti-parallel diode is connected in parallel to said switch S3 and a fourth said internal anti-parallel diode or a forth said external anti-parallel diode is connected in parallel to said switch S4.

4) The power conversion and energy storage device of claim 1, wherein said internal battery Bt1 comprises any number of battery cells connected in series or parallel.

5) The power conversion and energy storage device of claim 1, wherein said switch S1 and said switch S3 are closed and said switch S2 and said switch S4 are open, or said switch S1 and said switch S3 are open and said switch S2 and said switch S4 are closed, wherein said modular battery unit is configured for direct input-to-output operating mode states.

6) The power conversion and energy storage device of claim 1, wherein said modular battery unit further comprises an input battery cell Bt0, wherein said input battery cell comprises a positive terminal connected to port A and a negative terminal connected to said port B.

7) The power conversion and energy storage device of claim 6, wherein said switch S1 and said switch S2 are closed, and said switch S3 and said switch S4 are open, or where said switch S1 and said switch S2 are open, and said switch S3 and said switch S4 are closed, wherein said modular battery unit is configured for buck-boost operation.

8) The power conversion and energy storage device of claim 6, wherein said modular battery unit is configured for said direct input-to-output operating mode states and configured for said buck-boost operation when only one of said switches S1, S2, S3, or S4 is open while the other said switches are closed.

9) The power conversion and energy storage device of claim 6 further comprises a trailing input half bridge and a trailing output half bridge, wherein said trailing input half bridge comprises a Bx node disposed between a switch S0 and a switch S−1, wherein said switch S0 is connected between said Bx node and said port A, wherein said switch S−1 is connected between said Bx node and said port B, wherein said trailing output half bridge comprises a By node disposed between a switch S5 and a switch S6, wherein said switch S5 is connected between said By node and said port D, wherein said switch S6 is disposed between said By node and said port C, wherein any said switch is individually selected from the group consisting of a transistor with an internal anti-parallel diode, and a transistor with an external anti-parallel diode, wherein a single unit battery pack Un is formed between said input port Bx and said output port By.

10) The power conversion and energy storage device of claim 9, wherein any number of said singular base units are connected in cascade between said trailing input half bridge and said trailing output half bridge, wherein a flexbattery pack is formed.

11) The power conversion and energy storage device of claim 10, wherein any number of said flexbattery packs are connected in parallel, making a parallel connection of the internal battery cells of the parallel flexbattery units.

12) The power conversion and energy storage device of claim 10, wherein any number of said flexbattery packs are connected in series, making a series connection of the internal battery cells of the series flexbattery units.

13) The power conversion and energy storage device of claim 10, wherein any number of said flexbattery packs are connected in parallel and further connected together with a series of inductors.

14) The power conversion and energy storage device of claim 10, wherein any number of said flexbattery packs are connected in parallel and further connected together with a series of inductors disposed on each end of between said trailing input half bridge and said trailing output half bridge.

15) The power conversion and energy storage device of claim 10, wherein any number of said flexbattery packs comprising of any number of parallel and cascaded said flexbattery units are connected in parallel and further connected together with a series of inductors disposed on each end of between said trailing input half bridge and said trailing output half bridge.

16) The power conversion and energy storage device of claim 9 further comprising an output inductor Lout and a voltage source Usrc, wherein said output inductor Lout comprises an input port connected to said output port By and an output port connected to said voltage source Usrc, wherein said voltage source Usrc is connected between said output port By and said input port Bx and is configured to increase the energy storage level in the internal battery cells in the flexbattery pack.

17) The power conversion and energy storage device of claim 9 further comprising a current source Isrc, wherein said current source Isrc connected between said output port By and said input port Bx and is configured to increase the energy storage level in the internal battery cells in the flexbattery pack.

18) The power conversion and energy storage device of claim 17, wherein the current source is controlled such that the energy storage level in the internal battery cells in the flexbattery pack is increased.

19) The power conversion and energy storage device of claim 1, wherein said modular battery unit is connected in cascade with at least one other said modular battery unit.

20) The power conversion and energy storage device of claim 1, wherein said modular battery unit is connected in parallel with at least one other said modular battery unit.

21) The power conversion and energy storage device of claim 1, wherein said modular battery unit is arranged in a cascade of any number of said modular battery units.

22) The power conversion and energy storage device of claim 1 further comprising a switch S_{F} disposed between said internal node N1 and said inductor L1, wherein a fault isolation single modular battery unit is formed.

23) The power conversion and energy storage device of claim 22, wherein said switch S_{F} is selected from the group consisting of a transistor, and a combination of series and parallel transistors, a fuse, and a electromechanical switch, wherein any of the other said switches is individually selected from the group consisting of a transistor with an internal anti-parallel diode, and a transistor with an external anti-parallel diode.

24) The power conversion and energy storage device of claim 23, wherein a first said internal anti-parallel diode or a first said external anti-parallel diode is connected in parallel to said switch S1, a second said internal anti-parallel diode or a second said external anti-parallel diode is connected in parallel to said switch S2, a third said internal anti-parallel diode or a third said external anti-parallel diode is connected in parallel to said switch S3 and a fourth said internal anti-parallel diode or a forth said external anti-parallel diode is connected in parallel to said switch S4.
